(19) United States
(12) Patent Application Publication
(10) Pub. No.: US 2026/0006029 A1
(43) Pub. Date: Jan. 1, 2026

(54) MANAGEMENT OF VEHICLE NETWORK ACCESS

(71) Applicant: Electrified Power Holdco, LLC, Columbus, IN (US)

(72) Inventors: Scott Allen Rittenhouse, Nashville, IN (US); Sharika Krishna Kumar, Columbus, IN (US)

(21) Appl. No.: 19/249,647

(22) Filed: Jun. 25, 2025

Related U.S. Application Data
(60) Provisional application No. 63/665,668, filed on Jun. 28, 2024.

(51) Int. Cl. H04L 9/40; H04L 12/40; H04L 12/66; H04L 67/50

(52) U.S. Cl. CPC H04L 63/10; H04L 12/40; H04L 12/66; H04L 67/535; H04L 2012/40215; H04L 2012/40273

(57) ABSTRACT

A method is disclosed for controlled access to a vehicle network via a user device. Upon receiving an access request from the user device, vehicle data is retrieved to evaluate whether access conditions are met. A first indication is generated if the vehicle data confirms that predetermined access criteria are satisfied. In response to this indication, a gatekeeping device transitions from a first state, where access to the vehicle network is blocked, to a second state, where access is permitted. This dynamic, condition-based control mechanism enhances vehicle network security by ensuring that only authorized access is granted, based on real-time vehicle status or contextual data. The invention enables secure, automated, and flexible connectivity to in-vehicle systems, supporting a variety of use cases, including maintenance, remote diagnostics, or user personalization, while minimizing the risk of unauthorized intrusion.

### CROSS-REFERENCE TO RELATED PATENT APPLICATIONS

This application is a U.S. Non-Provisional Patent and claims the benefit of priority to U.S. Provisional Patent Application No. 63/665,668, filed Jun. 28, 2024, the entire content and disclosure of which is incorporated herein by reference.

### FIELD

The present disclosure relates to cybersecurity for vehicle networks; more particular aspects relate to managing access to a vehicle powertrain network.

### BACKGROUND

A vehicle can be configured to permit a computing device to access a controller area network (CAN) of the vehicle for maintenance and/or diagnostic services. Such access may require hardware and/or software specifications of the computing device.

### SUMMARY

The present architecture enables a dynamic method for supervising access to segmented vehicle networks in response to authenticated service interactions. Upon receiving access request data from a user device—such as a diagnostic or maintenance tool—the system control module evaluates vehicle data indicative of operational state, tool identity, or service readiness. This assessment determines whether predefined conditions for access are satisfied.

When these conditions are met, the system transitions a gatekeeping device—such as a relay, repeater, or equivalent switching mechanism—from an initial state in which downstream communication is electrically blocked, to an active state that permits the user device to engage with the previously isolated vehicle network. Once activated, the gatekeeping device completes a physical circuit that bridges the service interface to one or more internal CAN segments, enabling direct, high-integrity communication with target components for the duration of the permitted session.

This approach distinguishes itself from conventional architectures that rely on always-connected gateways or static message filters. In those configurations, the physical connectivity between public and private domains is continuous, with separation enforced only at the data layer. Such designs are inherently susceptible to misconfiguration or unexpected tool behavior, and they do not provide assurance that internal network domains are electrically unreachable when not in use.

By contrast, the disclosed method introduces physical segmentation that is not just logical or software-based but structurally enforced. Access is only granted after verification, and once granted, it exists solely for the period during which the access conditions remain satisfied. When those conditions lapse—whether through user disconnection, elapsed time, or a change in vehicle state—the gatekeeping device is returned to its initial configuration, restoring electrical isolation between the user device and the internal vehicle network.

In this way, the system offers a configurable, secure, and monitorable boundary between service interfaces and sensitive network domains. It preserves the benefits of network segmentation while supporting full diagnostic access under the control of defined system policies—bridging the gap between serviceability and architectural integrity.

While multiple embodiments are disclosed, still other embodiments of the present disclosure will become apparent to those skilled in the art from the following detailed description, which shows and describes illustrative embodiments of the disclosure. Accordingly, the drawings and detailed description are to be regarded as illustrative in nature and not restrictive.

### BRIEF DESCRIPTION OF THE DRAWINGS

FIG. 1 depicts an example vehicle having a vehicle network access manager, in accordance with embodiments of the present disclosure.

FIG. 2 depicts a flowchart of an example method for vehicle network access management, in accordance with embodiments of the present disclosure.

FIG. 3 depicts an example computing device that can be used in accordance with embodiments of the present disclosure.

FIG. 4 illustrates a system-level schematic showing selective physical access to private vehicle networks via a relay controlled by a system control module.

FIG. 5 depicts a functional schematic emphasizing physical network segmentation to prevent unintended access to powertrain components during non-service operation.

FIG. 6 is a schematic of an electrified vehicle.

While the disclosed subject matter is amenable to various modifications and alternative forms, specific embodiments have been shown by way of example in the drawings and are described in detail below. The intention, however, is not to limit the disclosure to the particular embodiments described. On the contrary, the disclosure is intended to cover all modifications, equivalents, and alternatives falling within the scope of the disclosure as defined by the appended claims.

### DETAILED DESCRIPTION

The present disclosure relates to cybersecurity for vehicle networks; more particular aspects relate to managing access to a vehicle powertrain network.

In some instances, a network (e.g., a controller area network (CAN)) of a vehicle system can facilitate sensitive data exchanges between vehicle components. During a vehicle servicing event, a servicing entity (e.g., a vehicle technician) may need to access to such data by a user device (e.g., tablet computer). However, in some instances, access to such data can be unauthorized and/or malicious, which can jeopardize the safety of the vehicle and/or an operator of the vehicle.

To address these and other challenges, embodiments of the present disclosure include a vehicle network access manager. In some embodiments, the vehicle network access manager can control a gatekeeping device (e.g., a switch or relay, CAN repeater, network gateway) to permit or deny access to one or more networks (e.g., a private secondary CAN) of a vehicle system. Such access can be permitted or denied based on whether access conditions and criteria are satisfied. For example, in some instances, the vehicle network access manager can activate the gatekeeping device (e.g., connect the gatekeeping device to a power source) to permit a service computer to communicate with one or more vehicle components by one or more networks of the vehicle system. In this example, the vehicle network access manager can permit such access in response to determining that a condition that the vehicle is stationary is satisfied. In a further example, the vehicle network access manager can deactivate the gatekeeping device (e.g., remove its power source) and terminate such access in response to determining that a data transfer between the service computer and a vehicle component resembles activity deemed impermissible.

Embodiments of the present disclosure can limit access to a vehicle network to a predetermined activity, such as an authorized vehicle servicing event (e.g., routine maintenance of the vehicle and/or vehicle components). By employing a network access manager to control a gatekeeping device, embodiments of the present disclosure can disable the gatekeeping device to block access to a CAN network. Accordingly, embodiments of the present disclosure can provide enhanced data security by physically severing a communication channel between a user device and a CAN network. Additionally, embodiments of the present disclosure can restrict access to the CAN network without disabling a control module of the CAN network.

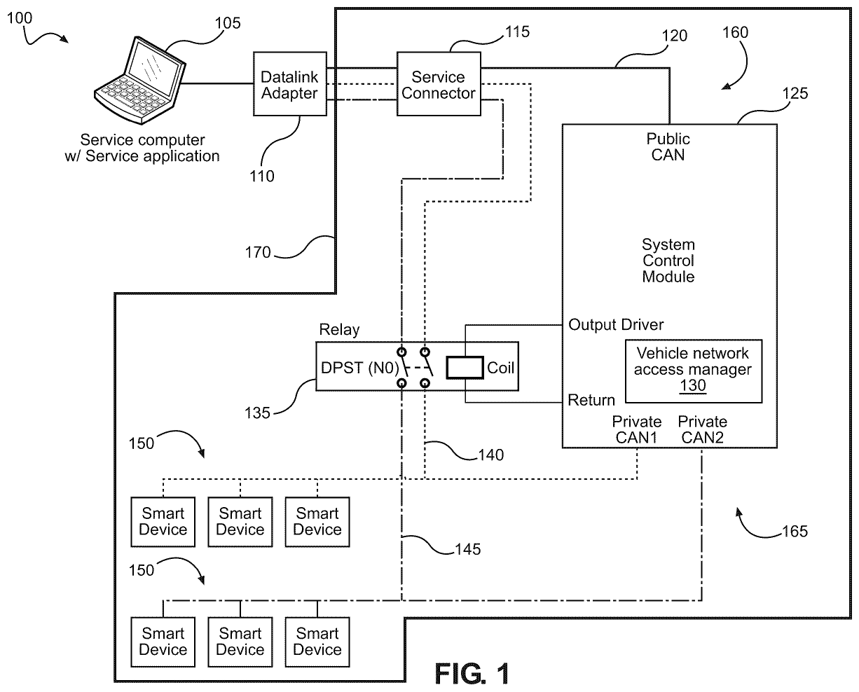

Turning to the figures, FIG. 1 illustrates a computing environment 100 that includes a vehicle network access manager 130.

In some embodiments, the vehicle network access manager can be integrated into a control module 125 (e.g., a system control module, engine control module, and the like) of the vehicle. For example, in some embodiments, network access manager can be a software component (e.g., a software module) of software installed on such a control module 125. In some embodiments, the vehicle network access manager can be a discrete module that is separate from a control module 125 of the vehicle. In some embodiments, the vehicle network access manager can include program instructions to monitor/analyze data to be transferred to and from a user device (e.g., user device 105) via a CAN network (e.g., CAN network 165). Continuing with this example, in response to determining that such data to be transferred is not to be permitted according to predetermined criteria, the vehicle network access manager can prevent the transfer of the data. In an example of preventing the transfer of the data, the vehicle network access manager can modify and/or direct the gatekeeping device 135 such that it has a first state (e.g., an inactive state). In some instances, the vehicle network access manager can prevent the transfer of data by maintaining the gatekeeping device in such a first state.

In some embodiments, the gatekeeping device can include a switch (e.g., a field effect transistor (FET)), CAN repeater, LIN (Local Interconnect Network) repeater, or network gateway). In some embodiments, a CAN repeater or a network gateway can facilitate managing vehicle network access in applications in which the vehicle networks have extended lengths. In an example, a CAN repeater can facilitate managing access to a CAN network of a bus (e.g., a school bus), in which one or more branches of the CAN network can have a physical length that is greater than a physical length for a branch of CAN network of a smaller vehicle (e.g., a sedan or other passenger vehicle). In some embodiments, a network gateway can facilitate an analysis of data transmitted via a CAN network. Such an analysis can enhance a degree of security associated with managing vehicle network access. In a manner similar to that discussed above with respect to the vehicle network access manager, the network gateway can include programming instructions to monitor/analyze data to be transferred to and from a user device 105 via the CAN network. Continuing with this example, in response to determining that such data to be transferred is not to be permitted according to predetermined criteria, the network gateway can prevent the transfer of the data.

In some embodiments, one or more vehicle components 150 connected to and configured to communicate via the one or more vehicle networks can include one or more devices such as a battery controller (e.g., a high-voltage battery controller), traction system controller, power converter (e.g., DC/DC converter), alternator, air compressor, power steering pump, thermal management system, vehicle accessories, and the like). In some embodiments, vehicle components 150 can employ the vehicle network 165 to transmit data such as history logs and/or histograms associated with operation of the respective vehicle components 150.

In some embodiments, control module 125 can include a plurality of CAN busses to which the plurality of vehicle components 150 can be connected for communication with other vehicle components 150, the control module 125, the vehicle network manager, the gatekeeping device, and/or the user device 105.

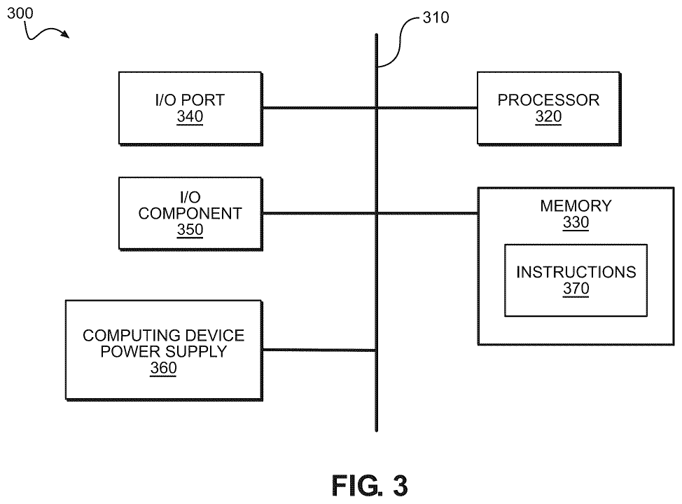

In some embodiments, user device 105 can include a desktop computer, notebook computer, tablet, and the like. In some embodiments, user device 105 can include a service computer, such as a computer configured to perform authorized maintenance and/or diagnostic procedures on the vehicle. In some embodiments, user device 105 can be identical or substantially similar to computing device 300, FIG. 3.

In some embodiments, vehicle 170 can include road vehicles (e.g., passenger vehicles (e.g., sedans), busses, commercial vehicles, construction vehicles, and the like). In some embodiments, vehicle can include trains, aquatic vehicles (e.g., boats) and/or air vehicles (e.g., airplanes).

In some embodiments, the vehicle can include a service connector 115 (e.g., on-board diagnostic port (e.g., OBD2 port), 9-pin round connector, and the like). Configured to be removably attached to a corresponding connector (e.g., datalink adapter 110) of the user device 105 to enable communication between the user device 105 and the vehicle.

In some embodiments, user device 105 and control module 125 can communicate by a first communication channel 120 of a primary network 160 that includes the user device 105, control module 125, and the vehicle network manager. In these embodiments, the vehicle network access manager employ the first communication channel 120 to receive and permit or deny requests by the user device 105 to access one or more secondary networks 165. The one or more secondary networks 165 can include the gatekeeping device, one or more vehicle components 150, control module 125, and vehicle network manager. The one or more secondary networks 165 can include one or more secondary communication channels 140, 145. Computing environment 100 includes a first secondary communication channel 140 and a second secondary communication channel 145. In some embodiments, the vehicle network access manager can control the gatekeeping device such that the user device 105 can employ the one or more secondary communication channels 140, 145 to communicate with the one or more vehicle components.

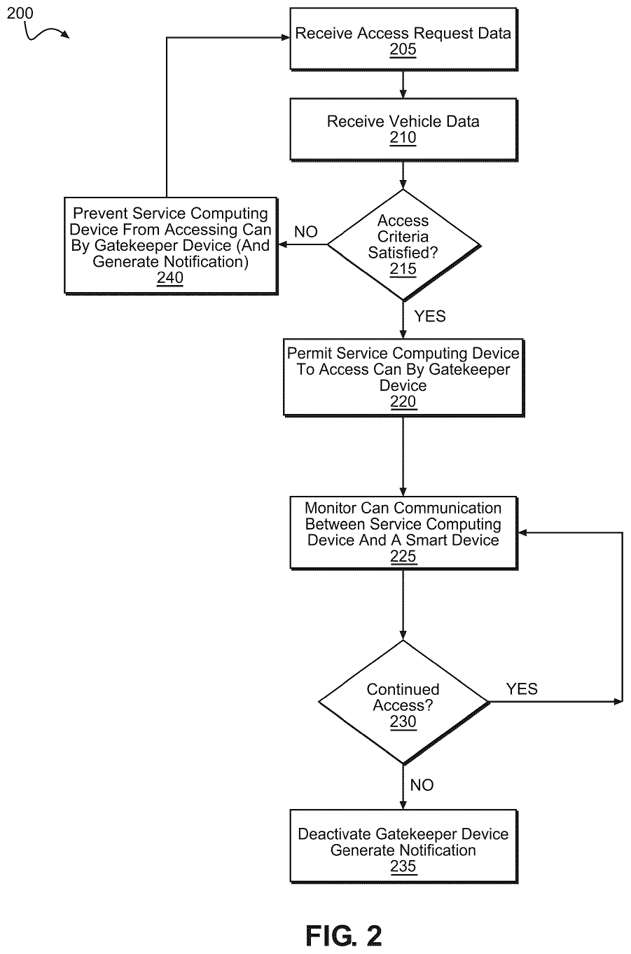

FIG. 2 illustrates a flowchart of an example method 200 for managing access to a vehicle network, in accordance with embodiments of the present disclosure. Method 200 can be performed by vehicle network access manager 130, FIG. 1.

In operation 205, the vehicle network access manager receives access request data. Access request data can include information associated with accessing one or more vehicle networks (e.g., one or more vehicle components of a vehicle network). In examples, access request data can include information associated with a vehicle component to which access is requested; information associated with data that is requested (e.g., information identifying that historical data is requested and/or that a particular histogram is requested); and/or authentication data of a user device requesting access (e.g., user device 105, FIG. 1). In some embodiments, vehicle network access manager can receive access request data from the user device.

In operation 210, the vehicle network access manager receives vehicle data. In some embodiments, the vehicle network access manager can receive vehicle data in response to receiving access request data in operation 205. In some embodiments, the vehicle network access manager can receive vehicle data in response to authenticating access request data received in operation 205. In an example, the vehicle network access manager can compare authentication information (e.g., a proprietary code) of the user device to predetermined verification information (e.g., a stored proprietary code). Continuing with this example, in response to identifying a match between the authentication information and the predetermined verification information, the vehicle network access manager can receive vehicle data. In some embodiments, the vehicle network access manager can receive vehicle data from a control module (e.g. a system control module) of the vehicle. In some embodiments, the vehicle network access manager can receive vehicle data from one or more vehicle components. In an example, in operation 210, in response to receiving access request data in operation 205, the vehicle network access manager can retrieve vehicle data from a traction system controller of the vehicle. In some embodiments, vehicle data can include information associated with a state of motion of the vehicle. For example, in some instances, vehicle data can include information regarding a vehicle speed, engine speed, a parked or unparked status of a vehicle, and/or an activated or deactivated status of a vehicle parking brake. In some instances, vehicle data can include one or more operation modes of the vehicle (e.g., one or more powertrain operations, such as a high voltage/active operation, an active charging operation, or an active update operation (e.g., over-the-air system update)).

In operation 215, the vehicle network access manager obtains (e.g., generates or receives) an indication whether one or more access conditions are satisfied. In some embodiments, operation 215 can include the vehicle access network manager comparing vehicle data obtained in operation 210 to one or more predetermined thresholds to determine whether the one or more predetermined thresholds are exceeded. In an example, the vehicle network access manager can be configured to permit access to the vehicle network in response to receiving one or more indications that the vehicle is not in motion (e.g., the vehicle is stationary and/or not propelled by its drivetrain). This configuration of the vehicle network access manager can be based on a determination that a vehicle network access request issued for a nonmoving vehicle is more likely associated with a legitimate activity (e.g., a proper, routine vehicle service) than an illegitimate activity (e.g., improper access, such as a hack, that could result in damage to the vehicle).

Accordingly, in some embodiments, operation 215 can include the vehicle network access manager comparing a vehicle speed received in operation 210 to a threshold speed of 0 km/h. In response to determining that the threshold speed is exceeded (e.g., the vehicle speed is 10 km/h), the vehicle network access manager can indicate that one or more access conditions are not satisfied. In some embodiments, operation 215 can include the vehicle network access manager comparing a vehicle status obtained in operation 210 to a predetermined status to determine whether the vehicle status matches the predetermined status. In an example, operation 215 can include the vehicle network access manager comparing an activated status of a vehicle parking brake obtained in operation 210 to a predetermined activated parking brake status. In this example, in response to determining that the vehicle status matches the predetermined status, the vehicle network access manager can indicate that one or more access conditions are satisfied. In some embodiments, data associated with such thresholds and/or predetermined statuses can be stored and/or received from a storage location of the vehicle, such as memory of a control module (e.g., a system control module) of the vehicle.

In response to obtaining an indication that the one or more access conditions are satisfied, the vehicle network access manager proceeds to operation 220. Alternatively, in response to determining that the one or more access conditions are not satisfied, the vehicle network access manager proceeds to operation 240.

In operation 220, the vehicle network access manager permits access to one or more vehicle networks by a gatekeeping device. In some embodiments, operation 220 can include the vehicle network access manager modifying a state of the gatekeeping device from a first state to a second state. In these embodiments, in response to the gatekeeping device having a first state, the gatekeeping device is configured to prevent the user device from accessing the vehicle network and/or one or more components of the vehicle connected to the vehicle network. Additionally in these embodiments, in response to the gatekeeping device having a second state, the gatekeeping device is configured to permit the user device to access the vehicle network and/or one or more components of the vehicle connected to the vehicle network. For example, in some instances, the vehicle network access manager can transition a CAN repeater from a first state, in which the CAN repeater is disabled and/or disconnected from a power source (e.g., a battery), to a second state, in which the CAN repeater is enabled and/or connected to a power source and powered. In such instances, in response to the CAN repeater having the first state, the CAN repeater blocks the user device from communicating with vehicle components via the vehicle network. Additionally, in response to the CAN repeater having the second state, the CAN repeater can function to facilitate communication between the user device and vehicle components via the vehicle network. In an example, the CAN repeater in the second state can repeat message data from a first CAN network to a second CAN network.

In operation 240, the vehicle network access manager prevents the user device from accessing the vehicle network and/or one or more components of the vehicle connected to the vehicle network. In some embodiments, operation 240 can include the vehicle network access manager refraining from modifying a state of the gatekeeping device from a first state. In some embodiments, operation 240 can include the vehicle network access manager verifying that the gatekeeping device has a first state and/or modifying the gatekeeping device such that it has a first state.

In operation 225, the vehicle network access manager receives communication activity data. Communication activity data can include information associated with the user device accessing the vehicle network. For example, in some embodiments, communication activity data can include a time and/or duration during which the user device accesses and/or is permitted to access the vehicle network. In some embodiments, communication activity can include information associated with a connection status of the user device and/or the gatekeeping device with the vehicle network (e.g., whether the user device and/or gatekeeping device becomes disconnected from the vehicle network). In some embodiments, communication activity data can include information associated with the content of data transmitted and/or received by the user device via the vehicle network. For example, in some instances, communication activity data can indicate a quantity of data transmitted and/or received by the user device via the vehicle network; a category of data (e.g., maintenance data, source code data, component specification data, and the like); and/or the actual data (e.g., commands/instructions, responses, code) transmitted and/or received by the user device via the vehicle network. In some embodiments, the vehicle network access manager can be configured to receive communication activity data from the user device, and/or control module, and/or the gatekeeping device, and/or a vehicle component.

In operation 230, the vehicle network access manager obtains (e.g., generates or receives) an indication whether one or more criteria for permitting continued access to the vehicle network are satisfied. In some embodiments, operation 230 can include the vehicle access network manager comparing communication activity data obtained in operation 225 to one or more predetermined thresholds to determine whether the one or more predetermined thresholds is exceeded. In some instances, the vehicle network access manager can indicate that one or more criteria for permitting continued access are not satisfied in response to determining that one or more predetermined thresholds is exceeded.

In some embodiments, operation 230 can include the vehicle access network manager comparing a status obtained in operation 225 (e.g., a connection status of user device) with a predetermined status to determine whether the obtained status matches the predetermined status. In some instances, the vehicle network access manager can indicate that criteria for permitting continued access are satisfied in response to determining that the obtained status matches the predetermined status. In an example, in response to determining that an obtained status of the user device matches a connected status (e.g., the user device is connected to the vehicle network), the vehicle network access manager can indicate that criteria for permitting continued access are satisfied. Alternatively, in response to determining that an obtained status of the user device matches a disconnected status (e.g., the user device is not connected to the vehicle network), the vehicle network access manager can indicate that criteria for permitting continued access are not satisfied.

In some embodiments, operation 230 can include the vehicle network access manager analyzing (1) data transmitted and/or received by the user device via the vehicle network and/or (2) metadata associated with such data. By such an analysis, the vehicle access network manager can determine whether the data and/or metadata indicates improper activity by the user device. Examples of such improper activity can include a transfer of malicious code capable of damaging and/or compromising the vehicle and/or a vehicle component; a transfer of proprietary and/or confidential information associated with the vehicle; and/or activity that exceeds the scope of authorized activity granted to the user device by the vehicle network access manager. In some embodiments, such analysis can include the vehicle access network manager comparing the aforementioned data and/or metadata to predetermined data and/or predetermined trend data to determine whether a match indicating improper activity is present. In some instances, the vehicle network access manager can indicate that one or more criteria for permitting continued access are not satisfied in response to determining an occurrence of improper activity by the user device.

In some embodiments, operation 230 can include the vehicle network access manager receiving updated data (e.g., vehicle data), and using the updated data, obtain an updated indication of whether the one or more access conditions analyzed in operation 215 are satisfied. In response to obtaining an updated indication that the one or more access conditions are not satisfied, the vehicle network access manager can indicate that one or more criteria for permitting continued access are not satisfied.

In response to obtaining an indication that the one or more criteria for permitting continued access are satisfied, the vehicle network access manager proceeds to operation 225. Alternatively, in response to determining that the one or more criteria for permitting continued access are not satisfied, the vehicle network access manager proceeds to operation 235.

In operation 235, the vehicle network access manager prevents the user device from accessing the vehicle network and/or one or more components of the vehicle connected to the vehicle network. In some embodiments, operation 235 can include the vehicle network access manager modifying the gatekeeping device such that it has a first state (e.g., a disabled, inactive state), in which the gatekeeping device is configured to block the user device from accessing the vehicle network and/or one or more components of the vehicle connected to the vehicle network. In an example, operation 235 can include the vehicle network access manager terminating a power supply to the gatekeeping device (e.g., disconnecting the gatekeeping device from a power source such that the gatekeeping device is unpowered). In some embodiments, operation 235 can include the vehicle network access manager generating a notification (e.g., an alphanumeric message, visual indicator, audible indicator, and the like) associated with limiting access to the vehicle network. In some instances, such as in response to the vehicle network access manager obtaining an indication that the gatekeeping device is disconnected from the vehicle network, operation 235 can include the vehicle network access manager generating a notification regarding a connection status.

FIG. 3 is a block diagram depicting an illustrative computing device 300, in accordance with embodiments of the disclosure. The computing device 300 may include any type of computing device suitable for implementing aspects of embodiments of the disclosed subject matter. Each of the various components shown and described in the Figures can contain their own dedicated set of computing device components, such as those shown in FIG. 3 and described below. For example, user device 105, control module 125, gatekeeping device, 135, and/or vehicle components 150, FIG. 1, can each include a set of components shown in FIG. 3 and described below.

In embodiments, the computing device 300 includes a bus 310 that, directly and/or indirectly, couples one or more of the following devices: a processor 320, a memory 330, an input/output (I/O) port 340, an I/O component 350, and a power supply 360. Any number of additional components, different components, and/or combinations of components may also be included in the computing device 300.

The bus 310 represents what may be one or more busses (such as, for example, an address bus, data bus, or combination thereof). Similarly, in embodiments, the computing device 300 may include a number of processors 320, a number of memory components 330, a number of I/O ports 340, a number of I/O components 350, and/or a number of power supplies 360. Additionally, any number of these components, or combinations thereof, may be distributed and/or duplicated across a number of computing devices.

In embodiments, the memory 330 includes computer-readable media in the form of volatile and/or nonvolatile memory and may be removable, nonremovable, or a combination thereof. Media examples include random access memory (RAM); read only memory (ROM); electronically erasable programmable read only memory (EEPROM); flash memory; optical or holographic media; magnetic cassettes, magnetic tape, magnetic disk storage or other magnetic storage devices; data transmissions; and/or any other medium that can be used to store information and can be accessed by a computing device. In embodiments, the memory 330 stores computer-executable instructions 370 for causing the processor 320 to implement aspects of embodiments of components discussed herein and/or to perform aspects of embodiments of methods and procedures discussed herein. The memory 330 can comprise a non-transitory computer readable medium storing the computer-executable instructions 370.

The computer-executable instructions 370 may include, for example, computer code, machine-useable instructions, and the like such as, for example, program components capable of being executed by one or more processors 320 (e.g., microprocessors) associated with the computing device 300. Program components may be programmed using any number of different programming environments, including various languages, development kits, frameworks, and/or the like. Some or all of the functionality contemplated herein may also, or alternatively, be implemented in hardware and/or firmware.

According to embodiments, for example, the instructions 370 may be configured to be executed by the processor 320 and, upon execution, to cause the processor 320 to perform certain processes. In certain embodiments, the processor 320, memory 330, and instructions 370 are part of a controller such as an application specific integrated circuit (ASIC), field-programmable gate array (FPGA), and/or the like. Such devices can be used to carry out the functions and steps described herein.

The I/O component 350 may include a presentation component configured to present information to a user such as, for example, a display device, a speaker, and/or the like, and/or an input component such as, for example, a microphone, a joystick, a satellite dish, a wireless device, a keyboard, a pen, a voice input device, a touch input device, a touch-screen device, an interactive display device, a mouse, and/or the like.

The devices and systems described herein can be communicatively coupled via a network, which may include a local area network (LAN), a wide area network (WAN), a cellular data network, via the internet using an internet service provider, and the like.

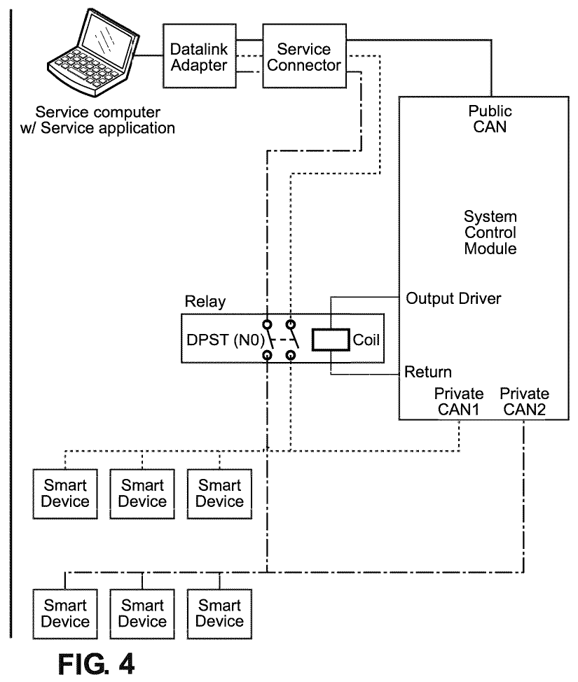

FIG. 4 is a system-level schematic diagram depicting a secured control architecture for selectively enabling physical access to onboard vehicle powertrain networks. The diagram illustrates components and interconnections used to enforce physical segmentation between public and private controller area networks (CANs), thereby preventing unauthorized access to sensitive subsystems during routine or diagnostic servicing.

A service computer 400, which may comprise a laptop or tablet executing a diagnostic or maintenance application, is communicatively coupled to a datalink adapter 405. The datalink adapter 405 is configured to interface with a service connector 410 of the vehicle, which may take the form of an OBD-II port, a 9-pin diagnostic connector, or other standardized interface. The service connector 410 provides physical routing of CAN signals between the service computer 400 and an onboard System Control Module (SCM) 415.

The SCM 415 includes a public CAN interface 420, which is persistently connected to the service connector 410 and used for general-purpose, low-security communications between the service computer 400 and the vehicle. The SCM also includes two additional, physically segregated interfaces—Private CAN1 425 and Private CAN2 430—intended for higher-security subsystems. These interfaces are connected to downstream powertrain components, such as battery controllers, traction inverters, thermal systems, and other smart devices requiring enhanced isolation.

The SCM 415 further includes an output driver 435 and a return line 440 configured to control actuation of a double-pole, single-throw (DPST) normally open (NO) relay 445. The relay 445 is shown with a coil 450 positioned to receive drive signals from the SCM's output circuitry. In its unpowered state, the relay 445 maintains an open connection, physically isolating the private CAN1 and CAN2 buses from the rest of the network.

A set of smart devices 455a-455c is connected to Private CAN1, and a second set of smart devices 460a-460c is connected to Private CAN2. These devices may include microcontroller-based components that implement Unified Diagnostic Services (UDS) and other protocols requiring secure, direct access to perform firmware updates, retrieve diagnostic logs, or execute service routines.

Functionally, FIG. 4 illustrates a secure and conditional approach to bridging public and private CAN domains using physical switching. The SCM 415 receives service tool communication via the public CAN interface 420 and evaluates incoming requests for access to the private networks. If the request is validated—based on system-level criteria such as vehicle operating status, tool authentication, or predefined access permissions—the SCM 415 energizes the relay coil 450 via the output driver 435. This actuation causes the DPST relay 445 to close both CAN lines, establishing a direct, physical connection from the service connector 410 to the private CAN1 and CAN2 networks.

The closed relay state enables the service computer 400 to communicate directly with the smart devices 455a-455c and 460a-460c without routing through a logical gateway or persistent software bridge. Once the service session concludes or a monitored abort condition is detected (e.g., vehicle begins motion, access timeout elapses, or unauthorized data patterns are observed), the SCM 415 deactivates the relay coil 450, causing the relay 445 to return to its default open state. This hardware-enforced segmentation ensures that the private networks remain inaccessible unless explicitly and securely authorized.

The architecture shown in FIG. 4 enables compliance with cybersecurity regulations such as UNECE R155 by providing deterministic, physical control over network segmentation. It eliminates the need for complex gateway reconfigurations or software firewalls during vehicle servicing, thereby reducing attack surface exposure while improving maintainability of mission-critical subsystems.

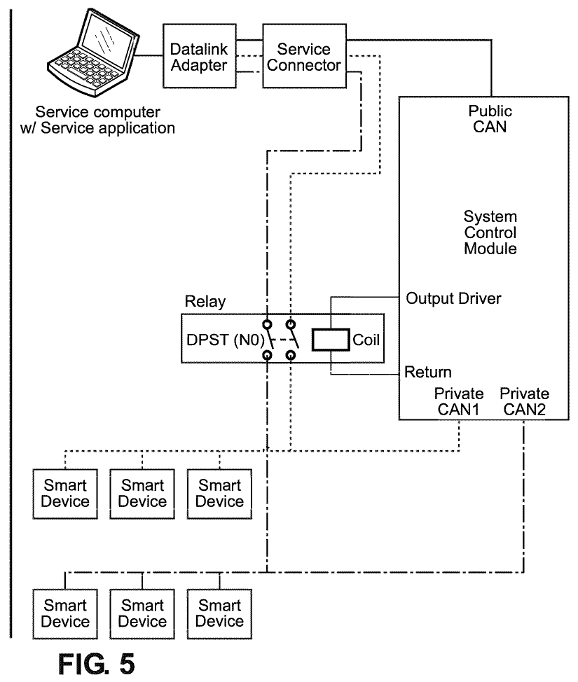

FIG. 5 is a system-level functional schematic illustrating an expanded view of the secure network segmentation architecture shown in FIG. 4, with emphasis on the cybersecurity vulnerabilities addressed by physical access control to onboard powertrain networks.

The depicted system includes a service computer 500 configured with a service application for performing diagnostics, firmware updates, or maintenance procedures. The service computer 500 connects through a datalink adapter 505 to a vehicle-mounted service connector 510. As in the prior embodiment, this connection facilitates initial communication over a public CAN bus routed to a System Control Module (SCM) 515.

The SCM 515 includes a public CAN interface 520 that continuously permits message exchange between the service computer 500 and the SCM for general-purpose operations. In addition to this public interface, the SCM features two private CAN interfaces: Private CAN1 525 and Private CAN2 530. These interfaces are electrically isolated from the service path under normal conditions.

To selectively bridge the service path to the private CAN buses, the SCM includes an output driver 535 and return path 540 configured to control a double-pole, single-throw (DPST), normally open (NO) relay 545. The relay 545 is actuated by a coil 550, which receives energizing signals from the SCM 515 when specific access control logic conditions are satisfied. The SCM manages both physical hardware control and internal policy enforcement based on service tool commands and vehicle status.

Downstream of the private CAN interfaces are two sets of smart devices: devices 555a-555c on Private CAN1 and devices 560a-560c on Private CAN2. These smart devices may represent traction control units, high-voltage battery management systems, thermal regulation controllers, or other sensitive powertrain components whose operational integrity is mission-critical and security-sensitive.

In terms of function, FIG. 5 demonstrates how physical network segmentation serves as a cybersecurity countermeasure. In traditional architectures lacking such segmentation, service connectors provide continuous electrical pathways to all internal CAN domains, including private subsystems. This configuration introduces a cybersecurity vulnerability: any entity that connects to the service port-legitimately or maliciously-could potentially issue diagnostic or control commands directly to critical powertrain components, bypassing gateway logic or relying on insufficient software-based firewalls.

The architecture shown in FIG. 5 addresses this risk by introducing an SCM-governed physical relay 545 that defaults to an open state. In this state, even if the service computer 500 is connected and transmitting data over the public CAN interface 520, there is no electrical pathway to the private CAN buses. The smart devices 555a-555c and 560a-560c remain isolated from all external service activity unless a valid request is received and approved.

When the SCM 515 receives a service request over the public CAN bus, it performs a multi-step validation process, which may include verifying the authenticity of the service tool, checking vehicle state conditions (e.g., speed=0, ignition status, parking brake engaged), and ensuring that the service session falls within an authorized use case (e.g., scheduled maintenance). Only upon successful validation does the SCM energize coil 550 to close relay 545, physically connecting the service tool to both private CAN buses.

Once servicing is complete or if any abort condition is detected—such as vehicle motion, relay dwell time expiration, communication anomaly, or loss of tool authentication—the SCM immediately de-energizes coil 550, returning relay 545 to its normally open position and re-isolating the private CAN buses.

FIG. 5 highlights the invention's ability to mitigate a key cybersecurity threat: the possibility that vehicle service interfaces may unintentionally expose internal networks to unauthorized actors. By interposing a hardware-controlled relay that is only closed under strict, software-enforced conditions, the disclosed system ensures that access to safety-critical or security-sensitive systems is both physically restricted and auditably controlled.

Modern powertrain systems are increasingly reliant on a range of networked electronic components that operate across segmented communication buses. These segments often include dedicated communication pathways for subsystems such as power conversion, battery control, and thermal regulation. While this segmentation provides a foundation for cybersecurity protections, it presents a longstanding challenge for serviceability: diagnostic tools must at times communicate directly with devices on otherwise isolated networks. Traditional approaches rely on gateway logic or persistent bridging to facilitate access, but such configurations leave the internal network topology continuously exposed-creating opportunities for unintended data flow, unauthorized tool interaction, or configuration drift during non-service operation.

The system presented here addresses a nuanced design tension: enabling expanded diagnostic and maintenance access without diminishing the architectural separation that supports secure network behavior. In conventional configurations, once a service port is physically connected, its access scope is largely fixed-either permitting full access to downstream networks or relying on software-layer enforcement that may itself be vulnerable to circumvention. These limitations make it difficult to reconcile secure system integration with flexible, field-level service demands.

### System Overview

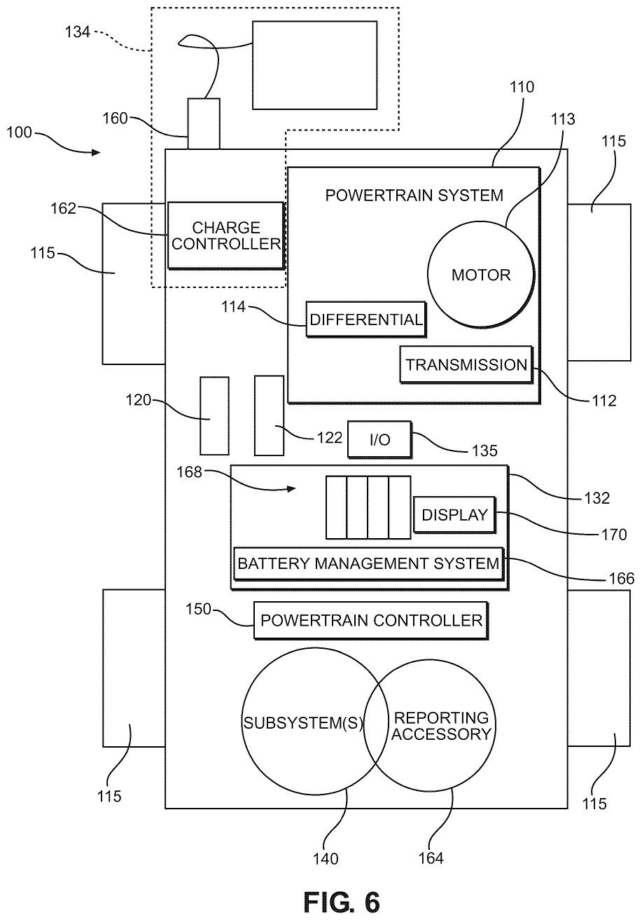

Referring now to FIG. 6, a schematic diagram of a battery electric vehicle 600 is provided. While the vehicle is referred to as a battery electric vehicle, it is understood that the vehicle may include a hybrid vehicle, such as a plug-in hybrid vehicle, powered or otherwise operable via a battery and, optionally, one or more of a generator (e.g., a power generator, generator plant, electric power strip, on-board rechargeable electricity storage system, etc.) and a motor (e.g., an electric motor, traction motor, etc.). Battery electric vehicle 600 may be operable in at least one of a reverse direction (e.g., a backward direction relative to a front end of battery electric vehicle 600) and a non-reverse direction (e.g., a forward direction, angular direction, etc., relative to the front end of battery electric vehicle 600). Battery electric vehicle 600 may be an on-road or off-road vehicle including, but not limited to, cars, trucks, ships, boats, vans, airplanes, spacecraft, or any other type of vehicle.

Battery electric vehicle 600 comprises a powertrain controller 650 communicably and operatively coupled to a powertrain system 610, a brake mechanism 620, an accelerator pedal 622, one or more sensors, an operator input/output (I/O) device 635, and one or more additional vehicle subsystems 640. Battery electric vehicle 600 may include additional, fewer, and/or different components systems than depicted in FIG. 6, such that the principles, methods, systems, apparatuses, processes, and the like of the present disclosure are intended to be applicable with any suitable vehicle configuration. It should also be understood that the principles of the present disclosure should not be interpreted to be limited to on-highway vehicles; rather, the present disclosure contemplates that the principles may also be applied to a variety of other applications including, but not limited to, off-highway construction equipment, mining equipment, marine equipment, locomotive equipment, etc.

Powertrain system 610 facilitates power transfer from a battery 632 and/or a motor 613 to power battery electric vehicle 600. In an exemplary embodiment, powertrain system 610 includes motor 613 operably coupled to battery 632 and charge system 634, where motor 613 transfers power to a final drive (e.g., wheels 615) to propel battery electric vehicle 600. As depicted, powertrain system 610 may include other various components, such as a transmission 612 and/or differential 614, where differential 614 transfers power output from transmission 612 to final drive 615 to propel battery electric vehicle 600. Powertrain controller 650 of battery electric vehicle 600 provides electricity to motor 613 (e.g., an electric motor) in response to various inputs received by powertrain controller 650, for example, from accelerator pedal 622, sensors, vehicle subsystems 640, charge system 634 (e.g., a battery charging system, rechargeable battery, etc.). In some embodiments, electricity provided to power motor 613 may be provided by an onboard gasoline-engine generator, a hydrogen fuel cell, etc.

In some embodiments, battery electric vehicle 600 may include transmission 612. Transmission 612 may be structured as any type of transmission compatible with battery electric vehicle 600, including a continuous variable transmission, a manual transmission, an automatic transmission, an automatic-manual transmission, or a dual clutch transmission, for example. Accordingly, as transmissions vary from geared to continuous configurations, transmission 612 may include a variety of settings (e.g., gears, for a geared transmission) that affect different output speeds based on an engine speed or motor speed. Like transmission 612, motor 613, differential 614, and final drive 615 may be structured in any configuration compatible with battery electric vehicle 600. In some embodiments, transmission 612 is omitted and motor 613 is directly coupled to differential 614. In other embodiments, motor 613 is directly coupled to final drive 615 as a direct drive application. In some examples, battery electric vehicle 600 may comprise multiple instances of motor 613, for example, one instance for each driven wheel, one instance per driven axle, or other compatible arrangements.

Brake mechanism 620 may be implemented as a brake (e.g., hydraulic disc brake, drum brake, air brake, etc.), braking system, or any other device configured to prevent or reduce motion by slowing or stopping components (e.g., a wheel, axle, pedal, crankshaft, driveshaft, etc. of battery electric vehicle 600). Generally, brake mechanism 620 is configured to receive an indication of a desired change in the vehicle speed. In some embodiments, brake mechanism 620 comprises a brake pedal operable between a released state and an applied state by an operator of battery electric vehicle 600. The brake pedal may be configured as a pressure-based system responsive to applied pressure or a travel-based system responsive to a travel distance of the pedal, where a force applied to brake mechanism 620 is proportional to the pressure and/or travel distance. In some embodiments, all or a portion of brake mechanism 620 is incorporated into motor 613, for example, as a regenerative brake mechanism.

Generally, the released state of brake mechanism 620 corresponds to a brake pedal in a default location where the brake mechanism is not applied, for example, when the operator's foot is not placed on the brake pedal at all, or merely resting on the brake pedal such that a minimum actuation force is not exceeded (e.g., a spring-assisted, hydraulic-assisted, or servo-assisted force that pushes the brake pedal to the default location). In some embodiments, the brake pedal is combined with accelerator pedal 622 in a one-pedal driving configuration. In some examples, the applied state of brake mechanism 620 may correspond to the brake pedal being pressed with a force that meets or exceeds the minimum actuation force. In other examples, the applied state of brake mechanism 620 corresponds to the brake pedal being pressed so that the travel distance of the brake pedal meets or exceeds a minimum travel distance. Generally, the minimum actuation force and/or minimum travel distance help to prevent accidental actuation of brake mechanism 620. Different levels of the minimum actuation force and/or minimum travel distance may be used for different implementations of brake mechanism 620, for example, relatively higher forces or travel distance for a foot-actuated brake pedal, relatively lower forces or travel distance for a hand-actuated brake lever. Although the brake pedal may have a range of pressures and/or travel distances that provide at least some braking effect on battery electric vehicle 600 (e.g., high pressures for hard or emergency braking, low pressures for gradual braking or “feathering” the brakes), this range of pressures and/or travel distances are within the applied state.

The released state may correspond to an indication of a desired increase in vehicle speed, while the applied state may correspond to an indication of a desired reduction in vehicle speed. In some embodiments, a reduction in actuation force and/or travel distance corresponds to a desired increase in vehicle speed, while an increase in actuation force and/or travel distance corresponds to a desired reduction in vehicle speed.

Accelerator pedal 622 may be structured as any type of torque and/or speed request device included with a system (e.g., a floor-based pedal, an acceleration lever, paddle or joystick, etc.). Sensors associated with accelerator pedal 622 and/or brake mechanism 620 may include a vehicle speed sensor that provides a vehicle speed signal corresponding to a vehicle speed of battery electric vehicle 600, an accelerator pedal position sensor that acquires data indicative of a depression amount of the pedal (e.g., a potentiometer), a brake mechanism sensor that acquires data indicative of a depression amount (pressure or travel) of brake mechanism 620, a coolant temperature sensor, a pressure sensor, an ambient air temperature, or other suitable sensors.

Battery electric vehicle 600 may include operator I/O device 635. Operator I/O device 635 may enable an operator of the vehicle to communicate with battery electric vehicle 600 and/or powertrain controller 650. Analogously, operator I/O device 635 enables battery electric vehicle 600 and/or powertrain controller 650 to communicate with the operator. For example, operator I/O device 635 may include, but is not limited to, an interactive display (e.g., a touchscreen) having one or more buttons, input devices, haptic feedback devices, an accelerator pedal, a brake pedal, a shifter or other interface for transmission 612, a cruise control input setting, a navigation input setting, or other settings or adjustments available to the operator. Via operator I/O device 635, powertrain controller 650 can also provide commands, instructions, and/or information to the operator or a passenger.

Battery electric vehicle 600 includes one or more vehicle subsystems 640, which may generally include one or more sensors (e.g., a speed sensor, ambient pressure sensor, temperature sensor, etc.), as well as any other subsystem that may be included with a vehicle. Vehicle subsystems 640 may also include torque sensors for one or more of motor 613, transmission 612, differential 614, and/or final drive 615. Other vehicle subsystems 640 may include a steering subsystem for managing steering functions, such as electrical power steering, and output information such as wheel position and fault codes corresponding to steering battery electric vehicle 600; an electrical subsystem which may include audio and visual indicators, such as hazard lights and speakers configured to emit audible warnings, as well as other functions; and a thermal management system, which may include components such as a radiator, coolant, pumps, fans, heat exchangers, computing devices, and associated software applications. Battery electric vehicle 600 may include further sensors other than those otherwise discussed herein, such as cameras, LIDAR, and/or RADAR, temperature sensors, smoke detectors, virtual sensors, among other potential sensors.

Powertrain controller 650 may be communicably and operatively coupled to powertrain system 610, brake mechanism 620, accelerator pedal 622, operator I/O device 635, and one or more vehicle subsystems 640. Communication between and among the components may be via any number of wired or wireless connections. For example, a wired connection may include a serial cable, a fiber optic cable, an SAE J1939 bus, a CAT5 cable, or any other form of wired connection. In comparison, a wireless connection may include the Internet, Wi-Fi, Bluetooth, Zigbee, cellular, radio, etc. In one embodiment, a controller area network (CAN) bus including any number of wired and wireless connections provides the exchange of signals, information and/or data. Powertrain controller 650 is structured to receive data (e.g., instructions, commands, signals, values, etc.) from one or more of the components of battery electric vehicle 600 as described herein via the communicable coupling of powertrain controller 650 to the systems and components of battery electric vehicle 600. In some embodiments, an additional or alternative controller may be used for receiving data from certain systems or components.

The present architecture introduces a system control module that supervises whether physical network pathways are electrically activated. Rather than relying on an always-on gateway or dual-purpose ECU, the design routes access through a selectively actuated switching device-such as a relay or repeater-placed in line with the isolated network segments. This switching device remains electrically open unless and until the system controller verifies that predefined access conditions have been satisfied. Such conditions may include validation of the service tool, confirmation of vehicle state (e.g., stationary, secure mode active), and other dynamic checks. Once verified, the system allows temporary physical connectivity for diagnostics or updates. When the access window closes—due to task completion, timeout, disconnection, or disallowed communication—the connection is physically disengaged, not simply masked.

This approach maintains the integrity of network boundaries while allowing full support for secure service interactions. It reduces the exposure associated with shared buses, avoids the need for persistent gateway programming, and enables a clean and auditable method of managing physical access across vehicle states.

The following practical examples illustrate how this design operates across a variety of real-world contexts, demonstrating how the system selectively enables access based on tool verification, vehicle condition, and monitored session behavior—while maintaining physical segmentation before and after the service event.

### Example 1: Authorized Firmware Update Via Physical Relay Activation

A service technician is performing a scheduled firmware update on a battery electric commercial van. The technician connects a rugged service laptop (service computer 400) to the vehicle using a datalink adapter (405) plugged into the service connector (410). The System Control Module (SCM 415) receives an access request via the public CAN interface (420). The request includes a digital signature unique to the authorized service tool.

Before granting access, the SCM 415 verifies the following:
The ignition key is in the “accessory” position.
The vehicle speed is zero and parking brake is engaged.
The diagnostic session is within an approved time window.

Upon satisfying these checks, the SCM energizes output driver (435) to power the relay coil (450), closing relay (445). This establishes a physical connection to Private CAN1 (425) and Private CAN2 (430), enabling direct communication between the service tool and smart devices (455a-455c and 460a-460c).

The firmware update proceeds as the service computer writes new data to the battery controller and inverter firmware modules. Throughout the process, the SCM monitors the session. If abnormal voltage or unexpected data patterns are detected, or if the vehicle is shifted into drive, the SCM immediately deactivates the coil, opening the relay and severing physical access.

### Example 2: Runtime Network Access Monitoring with Abort Conditions

During an in-field diagnostic session for a high-voltage inverter fault, an authorized technician connects to the vehicle with a validated service tool. The tool is authenticated by the SCM, which activates a relay to temporarily bridge the service interface to Private CAN1.

As diagnostics proceed, the SCM continuously monitors:
The duration of the CAN session,
The types of commands issued by the service computer, and
Vehicle operational state transitions (e.g., door open/close, ignition state).

Fifteen minutes into the session, the service technician inadvertently attempts to issue a control command normally restricted to development tools-specifically, a raw memory write command outside the allowed UDS service range. The SCM compares the command payload to a list of permitted diagnostic service identifiers and detects a violation.

In response, the SCM immediately de-energizes the relay, physically disconnecting the service port from the private CAN bus. It also generates a diagnostic event log and stores the triggering command sequence for audit purposes. This example demonstrates how the invention enforces policy not just at session initiation, but continuously through live session monitoring.

### Example 3: Secure Access for Fleet Depot Maintenance

At a fleet maintenance depot, a technician performs health checks on a series of electric buses equipped with onboard cooling loop controllers and battery thermal management units connected to isolated private CAN networks.

The technician connects a tablet to the service port. The system includes no permanently active gateway. Instead, access is controlled entirely by the SCM and a physical relay, which defaults to the open (disconnected) state.

Once the SCM receives an access request, it authenticates the tool and checks that the vehicle is connected to depot power and stationary. The relay is activated only when these conditions are met. The tablet is then able to retrieve system status logs from the smart thermal control devices for trending analysis and predictive maintenance.

This method enables fleet-wide servicing and diagnostic pull during non-operational hours while maintaining cybersecurity separation during route operation.

### Example 4: Compliance-Driven Physical Network Segmentation

To meet UNECE R155 requirements, a manufacturer implements the disclosed system architecture in a new battery-electric truck platform. During type approval certification, cybersecurity auditors verify that the diagnostic port does not provide physical access to safety-critical subsystems under normal operation.

Testing involves probing the diagnostic connector with a multimeter. During standard operation (vehicle on but not in service mode), the CAN pins show an open circuit-indicating that no physical termination is present on the private network. After an authorized service session is initiated and validated, the pins display proper termination resistance, confirming physical connectivity only occurs during authenticated events.

This approach avoids reliance on software-only gateways and demonstrates an architecture aligned with “hard-separation” principles preferred by regulators. It reduces system complexity and eliminates persistent bridging vulnerabilities by using deterministic, SCM-controlled switching.

### Example 5: Secure Access Using a CAN Repeater as the Switching Device

In a configuration where a CAN repeater functions as the gatekeeping device, the SCM governs whether the repeater is powered or unpowered. During standard vehicle operation, the repeater is unpowered, leaving the downstream CAN segments electrically isolated.

When the service tool sends an authenticated request, the SCM verifies access conditions (e.g., park brake engaged, tool certification valid, inverter temperature within limits), then powers the repeater. Once powered, the repeater enables bi-directional communication between the service computer and private network devices.

This setup allows high-speed and reliable servicing of distributed powertrain modules over long cable lengths (e.g., in articulated buses or heavy-duty trucks) while maintaining strict control over when such communication is physically possible. The use of a repeater also improves signal integrity in large vehicles without compromising security.

In Example 1, a method comprising: receiving vehicle data of a vehicle in response to receiving access request data from a user device, the access request data associated with accessing a vehicle network of the vehicle; obtaining a first indication that, based on the vehicle data, one or more conditions for permitting access to the vehicle network are satisfied; and directing, in response to the receiving the first indication, a state of a gatekeeping device from a first state to a second state, wherein: in the first state, the gatekeeping device prevents the user device from accessing the vehicle network, and in the second state, the gatekeeping device permits the user device to access the vehicle network.

In Example 2, the method as Example 1 describes, further comprising: receiving communication activity data associated with the user device accessing the vehicle network; obtaining an additional indication that, based on the communication activity data, one or more criteria for permitting continued access to the vehicle network are not satisfied; and directing, in response to the receiving the additional indication, the state of the gatekeeping device from the second state to the first state.

In Example 3, the method as either of Examples 1 or 2 describe, wherein the directing the state of the gatekeeping device from the second state to the first state comprises terminating a power supply to the gatekeeping device.

In Example 4, the method as any of Examples 1-3 describe, wherein the communication activity data comprises a duration of access to the vehicle network by the user device.

In Example 5, the method as any of Examples 1-4 describe, wherein the obtaining the additional indication comprises receiving an indication that the user device is disconnected from the vehicle network.

In Example 6, the method as any of Examples 1-5 describe, wherein the vehicle network comprises one or more components of the vehicle, the one or more components configured to communicate by the vehicle network.

In Example 7, the method as any of Examples 1-6 describe, wherein the one or more components comprise a battery controller, power converter, air compressor, power steering pump, or a thermal management system.

In Example 8, the method as any of Examples 1-7 describe, wherein in response to the gatekeeping device having the second state, the user device is configured to communicate with the one or more components by the vehicle network.

In Example 9, the method as any of Examples 1-8 describe, wherein the gatekeeping device comprises a field effect transistor, CAN repeater, or network gateway.

In Example 10, the method as any of Examples 1-9 describe, wherein the directing the state of the gatekeeping device from the first state to the second state comprises connecting a power source to the gatekeeping device.

In Example 11, the method as any of Examples 1-10 describe, wherein the vehicle data comprises a status of a parking brake of the vehicle.

In Example 12, the method as any of Examples 1-11 describe, wherein the obtaining the first indication comprises receiving an indication that the vehicle is not in motion.

In Example 13, the method as any of Examples 1-12 describe, wherein the first state comprises an unpowered state.

In Example 14, the method as any of Examples 1-13 describe, wherein the second state comprises a powered state.

In Example 15, a controller comprising: one or more processors; and one or more computer-readable storage media storing program instructions which, when executed by the one or more processors, cause the one or more processors to: receive vehicle data of a vehicle in response to receiving access request data from a user device, the access request data associated with accessing a vehicle network of the vehicle; obtain a first indication that, based on the vehicle data, one or more conditions for permitting access to the vehicle network are satisfied; and directing a state of a gatekeeping device from a first state to a second state, wherein: in the first state, the gatekeeping device prevents the user device from accessing the vehicle network, and in the second state, the gatekeeping device permits the user device to access the vehicle network.

In Example 16, the controller as Example 15 describes, wherein the program instructions are further configured to cause the one or more processors to: receive communication activity data associated with the user device accessing the vehicle network; obtain an additional indication that, based on the communication activity data, one or more criteria for permitting continued access to the vehicle network are not satisfied; and direct the state of the gatekeeping device from the second state to the first state in response to receiving the additional indication.

In Example 17, a system comprising: a user device configured to transmit access request data associated with accessing a vehicle network of a vehicle; a gatekeeping device configured to selectively permit or prevent access to the vehicle network; and a controller comprising one or more processors and one or more computer-readable storage media storing program instructions which, when executed by the one or more processors, cause the controller to: receive vehicle data of the vehicle in response to receiving the access request data from the user device; obtain a first indication that, based on the vehicle data, one or more conditions for permitting access to the vehicle network are satisfied; and direct a state of the gatekeeping device from a first state to a second state, wherein: in the first state, the gatekeeping device prevents the user device from accessing the vehicle network, and in the second state, the gatekeeping device permits the user device to access the vehicle network.

In Example 18, the system as Example 17 describes, wherein the gatekeeping device comprises a CAN repeater, relay, or network gateway, and the controller is further configured to provide or remove electrical power to the gatekeeping device to direct its state.

In Example 19, the system as either of Examples 17 or 18 describe, wherein the vehicle network includes one or more components comprising a battery controller, inverter, or thermal management unit, and wherein the gatekeeping device is configured to control access to the one or more components.

In Example 20, the system as any of Examples 17-19 describe, wherein the controller is further configured to: receive communication activity data associated with the user device accessing the vehicle network; obtain an additional indication that one or more criteria for continued access are not satisfied; and direct the state of the gatekeeping device from the second state to the first state in response to the additional indication.

### Guidance

The following section is intended to provide interpretive guidance for understanding and applying the principles set forth in this disclosure. It encapsulates key concepts related to adaptability, embodiment variation, structural flexibility, and claim interpretation. While it outlines several foundational principles by which one skilled in the art may assess scope and functionality, it is not exhaustive and should not be construed as limiting. Rather, it serves as a framework to ensure clarity, flexibility, and proper contextual understanding of the embodiments described, as well as their potential extensions and equivalents under applicable patent law.

The description provided herein is intended to accompany and explain the illustrated drawing for the purpose of instructing one skilled in the art in understanding representative embodiments of the disclosed system. Where terms such as “is,” “are,” or similar definitive language are used in connection with elements of the drawing, such phrasing should not be construed as limiting or exclusive. Rather, these terms are intended to reflect how a given feature can be implemented or depicted in the illustrated embodiment. As one skilled in the art will readily appreciate, the described configurations are not exhaustive and do not preclude alternative forms, functions, or arrangements that achieve similar objectives. The drawing is thus illustrative, not restrictive, and should be interpreted as one example among many possible implementations consistent with the broader principles disclosed.

Although the vehicle start procedure and associated voltage matching and safe contactor closure strategies have been described primarily in connection with electric vehicles utilizing one or more high-voltage battery packs, the disclosed systems and methods are equally applicable to other energy storage platforms and vehicle architectures. This includes hybrid electric vehicles, plug-in hybrids, fuel cell vehicles, and other systems that involve high-voltage energy management and contactor sequencing. The described voltage matching, stabilization timing, safe closure margin enforcement, and predictive maintenance algorithms are suitable for any application where safe and controlled high-voltage electrical connections are critical, such as in energy storage systems for stationary power, grid-tied applications, or industrial machinery. This flexible approach ensures safe system operation, protects electrical components from damage due to transients or inrush currents, and supports reliable long-term performance across diverse high-voltage applications.

The embodiments and examples set forth in the detailed description are intended to be illustrative and not exhaustive. While specific implementations have been described, they represent only a subset of potential configurations and applications that may be developed based on the disclosure provided herein. Features from one embodiment may be combined with features from another, whether or not such combinations are explicitly shown. Likewise, individual features may be omitted from particular embodiments without departing from the scope of the claims. All such combinations, omissions, and adaptations that would be apparent to a person of ordinary skill in the art are considered within the scope of this disclosure.

Additionally, for clarity and case of understanding, certain ancillary features commonly associated with exhaust treatment systems—such as control circuitry, power interfaces, fasteners, brackets, insulation layers, electrical connectors, or detailed housing structures—may be omitted or simplified in the drawings and description. Their presence, design, and implementation are well understood by those of skill in the art and are not required to be shown in full detail to convey the principles of the present disclosure. More complete representations of such supporting components may be included in production-level documentation or engineering drawings, as appropriate.

Ranges provided herein should be understood to include both their endpoints unless explicitly stated otherwise. A recited range may include intermediate values as well, but need not do so. Where a single value or limit is provided without a specified range, it should be interpreted as encompassing that value and all values functionally equivalent to it—including values that vary within manufacturing tolerances or fall within a nearby range—as would be recognized by a person of ordinary skill in the art under the doctrine of equivalents.

Terms such as “approximately,” “generally,” and “substantially” are intended to accommodate reasonable variations in implementation, including those arising from engineering tolerances, material substitutions, or minor deviations that do not materially alter the intended function. These modifiers are not intended to narrow the scope of the claims to precise numeric boundaries unless explicitly stated.

Use of “or” in lists should be interpreted inclusively unless the context dictates otherwise, meaning that any one, any combination, or all listed items may be encompassed. The phrase “at least one of A, B, and C” should be understood to mean any of A, B, or C individually or in combination, including all of them together. Use of “a portion” may refer to part or all of a given structure or element, and should not be construed to require partiality unless clearly indicated.

As used herein, the terms “coupled,” “connected,” or “joined” may encompass direct or indirect relationships between components. These relationships may be mechanical, thermal, electrical, fluidic, or otherwise, and may be fixed, moveable, integral, or modular. References to components being “fluidly coupled” should be interpreted to include arrangements that permit fluid flow-such as air, exhaust, DEF, or other working fluids-between components, either directly or through intervening structures such as ports, passages, valves, or manifolds.

Where method steps are presented in a particular sequence, that sequence is not intended to be limiting unless explicitly required. Steps may be performed in different orders, combined, performed in parallel, or omitted entirely depending on the desired implementation. Recitations of method operations are intended to provide illustrative guidance, not to restrict flexibility in procedural execution unless the claims specify otherwise.

The construction, configuration, and arrangement of components described throughout this disclosure are intended to be illustrative rather than limiting. All modifications, substitutions, equivalents, or alternatives that achieve the described function using different structures or configurations—whether known now or developed in the future—are contemplated to be within the scope of the claims. Protection is intended not only for the literal language of the claims, but also for all equivalents under applicable doctrines of patent law, including the doctrine of equivalents.

Aspects of the present disclosure are described with reference to flowchart illustrations and/or block diagrams of methods, devices, systems and computer program products. It will be understood that each block of the flowchart illustrations and/or block diagrams, and combinations of blocks in the flowchart illustrations and/or block diagrams, can be implemented by computer program instructions.

Various modifications and additions can be made to the exemplary embodiments discussed without departing from the scope of the disclosed subject matter. For example, while the embodiments described above refer to particular features, the scope of this disclosure also includes embodiments having different combinations of features and embodiments that do not include all of the described features. Accordingly, the scope of the disclosed subject matter is intended to embrace all such alternatives, modifications, and variations as fall within the scope of the claims, together with all equivalents thereof.

We claim:

1. A method comprising:
receiving vehicle data of a vehicle in response to receiving access request data from a user device, the access request data associated with accessing a vehicle network of the vehicle;
obtaining a first indication that, based on the vehicle data, one or more conditions for permitting access to the vehicle network are satisfied; and
directing, in response to the receiving the first indication, a state of a gatekeeping device from a first state to a second state, wherein:
in the first state, the gatekeeping device prevents the user device from accessing the vehicle network, and
in the second state, the gatekeeping device permits the user device to access the vehicle network.

2. The method of claim 1, further comprising:
receiving communication activity data associated with the user device accessing the vehicle network;
obtaining an additional indication that, based on the communication activity data, one or more criteria for permitting continued access to the vehicle network are not satisfied; and
directing, in response to the receiving the additional indication, the state of the gatekeeping device from the second state to the first state.

3. The method of claim 1, wherein the vehicle network comprises one or more components of the vehicle, the one or more components configured to communicate by the vehicle network.

4. The method of claim 3, wherein the one or more components comprise a battery controller, power converter, air compressor, power steering pump, or a thermal management system.

5. The method of claim 3, wherein in response to the gatekeeping device having the second state, the user device is configured to communicate with the one or more components by the vehicle network.

6. The method of claim 1, wherein the gatekeeping device comprises a field effect transistor, CAN repeater, or network gateway.

7. The method of claim 1, wherein the directing the state of the gatekeeping device from the first state to the second state comprises connecting a power source to the gatekeeping device.

8. The method of claim 2, wherein the directing the state of the gatekeeping device from the second state to the first state comprises terminating a power supply to the gatekeeping device.

9. The method of claim 1, wherein the vehicle data comprises a status of a parking brake of the vehicle.

10. The method of claim 1, wherein the obtaining the first indication comprises receiving an indication that the vehicle is not in motion.

11. The method of claim 1, wherein the first state comprises an unpowered state.

12. The method of claim 1, wherein the second state comprises a powered state.

13. The method of claim 2, wherein the communication activity data comprises a duration of access to the vehicle network by the user device.

14. The method of claim 2, wherein the obtaining the additional indication comprises receiving an indication that the user device is disconnected from the vehicle network.

15. A controller comprising:
one or more processors; and
one or more computer-readable storage media storing program instructions which, when executed by the one or more processors, cause the one or more processors to:
receive vehicle data of a vehicle in response to receiving access request data from a user device, the access request data associated with accessing a vehicle network of the vehicle;
obtain a first indication that, based on the vehicle data, one or more conditions for permitting access to the vehicle network are satisfied; and
directing a state of a gatekeeping device from a first state to a second state,
wherein:
in the first state, the gatekeeping device prevents the user device from accessing the vehicle network, and
in the second state, the gatekeeping device permits the user device to access the vehicle network.

16. The controller of claim 15, wherein the program instructions are further configured to cause the one or more processors to:
receive communication activity data associated with the user device accessing the vehicle network;
obtain an additional indication that, based on the communication activity data, one or more criteria for permitting continued access to the vehicle network are not satisfied; and
direct the state of the gatekeeping device from the second state to the first state in response to receiving the additional indication.

17. A system comprising:
a user device configured to transmit access request data associated with accessing a vehicle network of a vehicle;
a gatekeeping device configured to selectively permit or prevent access to the vehicle network; and
a controller comprising one or more processors and one or more computer-readable storage media storing program instructions which, when executed by the one or more processors, cause the controller to:
receive vehicle data of the vehicle in response to receiving the access request data from the user device;
obtain a first indication that, based on the vehicle data, one or more conditions for permitting access to the vehicle network are satisfied; and
direct a state of the gatekeeping device from a first state to a second state, wherein:
in the first state, the gatekeeping device prevents the user device from accessing the vehicle network, and
in the second state, the gatekeeping device permits the user device to access the vehicle network.

18. The system of claim 17, wherein the gatekeeping device comprises a CAN repeater, relay, or network gateway, and the controller is further configured to provide or remove electrical power to the gatekeeping device to direct its state.

19. The system of claim 17, wherein the vehicle network includes one or more components comprising a battery controller, inverter, or thermal management unit, and wherein the gatekeeping device is configured to control access to the one or more components.

20. The system of claim 17, wherein the controller is further configured to:
receive communication activity data associated with the user device accessing the vehicle network;
obtain an additional indication that one or more criteria for continued access are not satisfied; and
direct the state of the gatekeeping device from the second state to the first state in response to the additional indication.
